(19) United States
(12) Patent Application Publication
(10) Pub. No.: US 2016/0349451 A1
(43) Pub. Date: Dec. 1, 2016

(54) OPTICAL CONNECTION MODULE

(71) Applicant: CENTERA Photonics Inc., Hsinchu (TW)

(72) Inventors: Po-Kuan SHEN, Miaoli County (TW); Hsiao-Chin LAN, New Taipei City (TW); Tzu-Ching YEH, Hsinchu County (TW); Chin-Ta CHEN, Changhua County (TW); Shang-Jen YU, Hsinchu County (TW)

(21) Appl. No.: 15/162,623

(22) Filed: May 24, 2016

Related U.S. Application Data
(60) Provisional application No. 62/166,015, filed on May 25, 2015.

(51) Int. Cl. G02B 6/12; G02B 6/42

(52) U.S. Cl. CPC G02B 6/12019; G02B 6/12011; G02B 6/4214

(57) ABSTRACT

An optical connection module includes a substrate, an arrayed wavelength grating structure, an optical detector, and an oblique surface. The arrayed wavelength grating structure is disposed on the substrate and the arrayed wavelength grating structure is configured to transmit a light. The optical detector is disposed on the substrate, and the optical detector is configured to detect the light propagating through the arrayed wavelength grating structure. The oblique surface is configured to redirect the light from the arrayed wavelength grating structure to the optical detector.

### RELATED APPLICATIONS

This application claims priority to U.S. Provisional Application Ser. No. 62/166,015, filed May 25, 2015, which is herein incorporated by reference.

### BACKGROUND

Technical Field

The present disclosure relates to an optical connection.

Description of Related Art

In recent years, with the increasing development of optical communication, an optical connection module has drawn much attention. In general, the optical connection module may include an arrayed wavelength grating (hereafter abbreviated as AWG) structure and an optical detector. The AWG structure is configured to receive lights from a light source and to separate the lights within different wavelength ranges, and the lights within different wavelength ranges may be transmitted to the optical detector through different paths. However, because the optical detector is a surface-type light receiving device, an optical receiving surface of the optical detector is preferably perpendicular to a output light path of the AWG structure, and thus it is difficult to be located parallel with a main surface of a circuit board. Therefore, a circuit on the optical receiving surface of the optical detector has to be bended to a lateral surface of the optical detector, thereby benefiting to connect the optical detector and a device on the main surface of the circuit board. Nevertheless, such an out-of-plane bended circuit may interfere in a high frequency signal transmission of the optical connection module.

### SUMMARY

The disclosure relates to an optical connection module, which may prevent the circuit from the out-of-plane bending of the circuit, thereby benefiting to transmit the high frequency signal.

In accordance with some embodiments of the present disclosure, an optical connection module includes a substrate, an AWG structure, an optical detector, and an oblique surface. The AWG structure is disposed on the substrate, and the AWG structure is configured to transmit a light. The optical detector is disposed on the substrate, and the optical detector is configured to detect the light propagating through the AWG structure. The oblique surface is configured to redirect the light from the AWG structure to the optical detector.

In accordance with some embodiments of the present disclosure, the AWG structure has a light input portion and a light output portion that are opposite, and the oblique surface connects to the light output portion.

In accordance with some embodiments of the present disclosure, the oblique surface is located on the AWG structure.

In accordance with some embodiments of the present disclosure, the AWG structure has a first surface and a second surface connected with the oblique surface, the first surface opposite to the second surface is closer to the optical detector, and an angle formed by the oblique surface and the first surface is an acute angle.

In accordance with some embodiments of the present disclosure, an angle formed by the oblique surface and the second surface is an obtuse angle.

In accordance with some embodiments of the present disclosure, the AWG structure includes a first cladding layer, a second cladding layer and an AWG layer. The first cladding layer is closer to the optical detector than the second cladding layer being. The AWG layer is sandwiched between the first cladding layer and the second cladding layer, and has an end part connected to the first cladding layer and the second cladding layer. The oblique surface is located on the end part, and the first cladding layer and the AWG layer define a first interface that connects to the oblique surface and forms an angle with each other.

In accordance with some embodiments of the present disclosure, the second cladding layer and the AWG layer define a second interface that connects to the oblique surface and forms an angle with each other.

In accordance with some embodiments of the present disclosure, at least one of the first cladding layer and the second cladding layer has an auxiliary oblique surface that is extended to the oblique surface, and the auxiliary oblique surface and the oblique surface are substantially coplanar.

In accordance with some embodiments of the present disclosure, the optical connection module further includes a reflective layer disposed on the oblique surface.

In accordance with some embodiments of the present disclosure, the reflective layer has a reflective surface distant from the oblique surface and the reflective surface is substantially parallel with the oblique surface.

In accordance with some embodiments of the present disclosure, the substrate has a protrusion portion and a base portion, the protrusion portion protrudes from the base portion, and the oblique surface is formed on the substrate and connects the protrusion portion and the base portion, the optical detector is disposed on the protrusion portion, and the AWG structure is disposed on the base portion.

In accordance with some embodiments of the present disclosure, the optical connection module further includes at least one bonding pad, and the bonding pad is sandwiched between the substrate and the AWG structure.

In accordance with some embodiments of the present disclosure, the substrate has at least one engagement structure, the engagement structure is father away from the optical detector than the AWG structure being, and the engagement structure is configured to engage an optical passive device.

In accordance with some embodiments of the present disclosure, the substrate has at least one engagement structure, the AWG structure is engaged with the engagement structure.

In the foregoing embodiments, the optical connection module utilizes an oblique surface such that the light from the AWG structure can be redirected to the optical detector, so that the optical receiving surface of the optical detector is not necessarily perpendicular to a output light path of the AWG structure. Therefore, a circuit on the optical receiving surface of the optical detector is not required to be bended from the receiving surface to a lateral surface of the optical detector, thereby avoiding the out-of-plane bended circuit, which may benefit to transmit the high frequency signal.

It is to be understood that both the foregoing general description and the following detailed description are by examples, and are intended to provide further explanation of the invention as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a cross-section view of an optical connection module in accordance with some embodiments of the present disclosure.

FIG. 2 is an enlarged schematic view of an AWG structure in accordance with some embodiments of the present disclosure.

FIG. 3 is a bottom view of FIG. 2.

FIG. 4 is an enlarged schematic view of an AWG structure in accordance with other embodiments of the present disclosure.

FIG. 5 is a cross-section view of an optical connection module in accordance with other embodiments of the present disclosure.

FIG. 6 is a cross-section view of an optical connection module in accordance with other embodiments of the present disclosure.

FIG. 7 is a cross-section view of an optical connection module in accordance with other embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

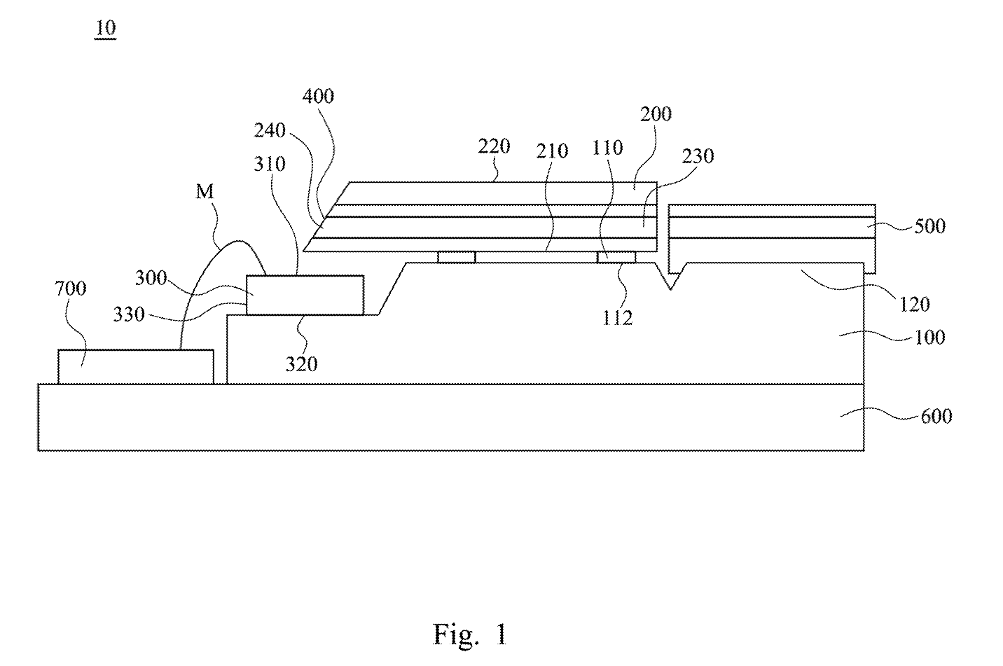

FIG. 1 is a cross-section view of an optical connection module 10 in accordance with some embodiments of the present disclosure. As shown in FIG. 1, an optical connection module 10 may include a substrate 100, an arrayed wavelength grating (hereafter abbreviated as AWG) structure 200 disposed on the substrate 100, an optical detector 300 disposed on the substrate 100, and an oblique surface 400. The AWG structure 200 is configured to transmit a light. The optical detector 300 is configured to detect the light which propagates through the AWG structure 200. The oblique surface 400 is configured to redirect the light from the AWG structure 200 to the optical detector 300.

In the foregoing embodiment of this disclosure, since the optical connection module 10 utilizes the oblique surface 400 to make the light from the AWG structure 200 be redirected to the optical detector 300, an out-of-plane bending of a circuit on the optical detector 300 can be prevented, which may benefit to transmit high frequency signals. More particularly, the optical detector 300 has a receiving surface 310 and a lateral surface 330 adjacent to the receiving surface 310. Since the oblique surface 400 may redirect the light from the AWG structure 200 to the optical detector 300, the receiving surface 310 of the optical detector 300 is not required to be perpendicular to an output light path of the AWG structure 200. Therefore, a wire M may directly connect the circuit on the receiving surface 310, so the circuit on the optical detector 300 (not shown in the figure) is not required to be bended intentionally from the receiving surface 310 to the lateral surface 330 of the optical detector 300 to connect the wire M, thereby avoiding the out-of-plane bended circuit presenting on the optical detector 300, which may benefit to transmit the high frequency signals.

More particularly, in some embodiments, as shown in FIG. 1 the AWG structure 200 has a light input portion 230 configured to receive the light, and an opposite light output portion 240 configured to emit the light in the AWG structure 200. The light input portion 230 is farther away from the optical detector 300 than the light output portion 240, and the light output portion 240 may connect the oblique surface 400. When the light emitted by the light output portion 240 arrives at the oblique surface 400, the light is reflected by the oblique surface 400 to the underlying optical detector 300, so the oblique surface 400 can redirect the light from the arrayed-wavelength structure 200 to the optical detector 300.

In some embodiments, as shown in FIG. 1, the optical detector 300 has a receiving surface 310 and an opposite rear surface 320 bonded to the substrate 100. At least a portion of the receiving surface 310 is located directly below the oblique surface 400, so it is beneficial that the oblique surface 400 redirects the light from the AWG structure 200 to the receiving surface 310 of the optical detector 300 by reflection.

In some embodiments, as shown in FIG. 1, the AWG structure 200 and the optical detector 300 are disposed on the same substrate 100, and the substrate 100 is integrally formed so it may reduce the optical path length between the arrayed-wavelength structure 200 and the optical detector 300. In other words, the substrate 100 where the AWG structure 200 and the optical detector 300 are disposed is integrally formed, so as to reduce the optical path length of the light leaving from the AWG structure 200 to the optical detector 300. For example, the substrate 100 may be, but is not limited to be, an integrally formed silicon substrate or semiconductor substrate. Since the substrate 100 where the AWG structure 200 and the optical detector 300 are disposed is integrally formed, the optical path between the AWG structure 200 and the optical detector 300 can be shortened, which may benefit to increase the optical coupling efficiency of the AWG structure 200 and the optical detector 300. Therefore, in some embodiments, additional optical lenses between the optical detector 300 and the oblique surface 400 configured to increase the optical coupling efficiency may be omitted. Of course, in some embodiments, the optical lenses may be disposed between the optical detector 300 and the oblique surface 400 to further increase the optical coupling efficiency.

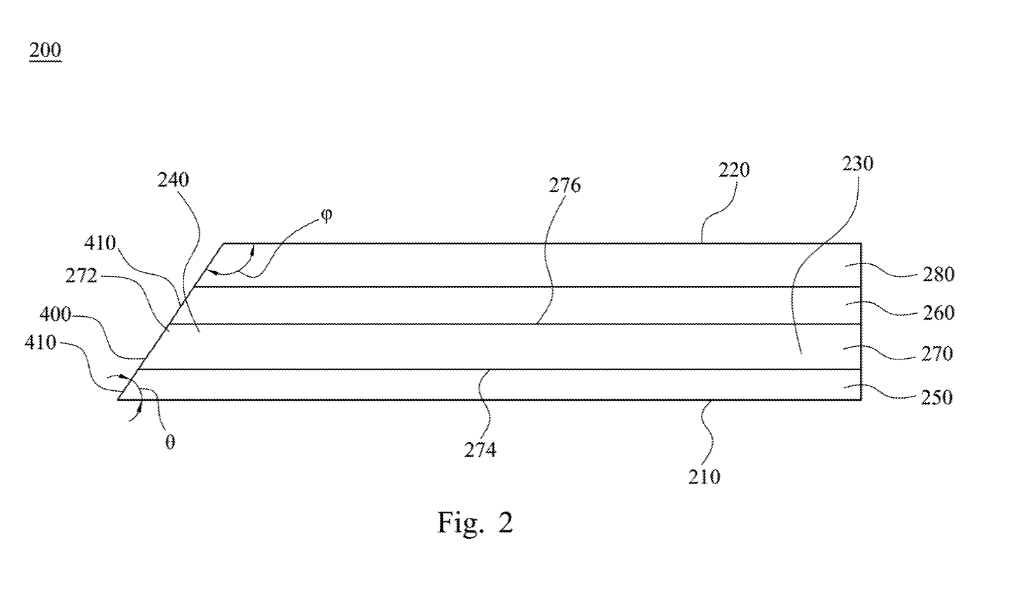

Reference is made to FIG. 2, which is an enlarged schematic view of the AWG structure 200 in accordance with some embodiments of the present disclosure. In some embodiments, the oblique surface 400 is located on the AWG structure 200. As shown in FIG. 2, the oblique surface 400 is disposed on the light output portion 240 of the AWG structure 200. As a result, the distance that the light propagates from the AWG structure 200 to the oblique surface 400 can be reduced, thereby reducing the optical energy loss, which may benefit to increase the optical coupling efficiency of the light transmitted from the AWG structure 200 to the optical detector 300.

In some embodiments, as shown in FIG. 1 and FIG. 2, the AWG structure 200 may include a first surface 210 and a second surface 220 connected with the oblique surface 400. The first surface 210 opposite to the second surface 220 is closer to the optical detector 300 than the second surface 220 being. The oblique surface 400 is connected between the first surface 210 and the second surface 220. An angle θ formed by the oblique surface 400 and the first surface 210 is an acute angle. In other words, the first surface 210 and the oblique surface 400 may form an angle θ therebetween, and the angle θ is less than 90°.

In some embodiments, as shown in FIG. 1 and FIG. 2, an angle Φ formed by the oblique surface 400 and the second surface 220 is an obtuse angle. In other words, the second surface 220 and the oblique surface 400 may form an angle Φ therebetween, and the angle Φ is greater than 90°.

Referring to FIG. 2, in some embodiments, the AWG structure 200 may include a first cladding layer 250, a second cladding layer 260 and an AWG layer 270. The first cladding layer 250 is closer to the optical detector 300 than the second cladding layer 260 being. In other words, the second cladding layer 260 is farther away from the optical detector 300 than the first cladding layer 250 being. The AWG layer 270 is sandwiched between the first cladding layer 250 and the second cladding layer 260, and may have an end part 272 where the oblique surface 400 is located. The first cladding layer 250 and the AWG layer 270 may define a first interface 274 that connects to the oblique surface 400 and forms an angle with each other. In some embodiments, the first cladding layer 250 and the second cladding layer 260 may have refractive index less than that of the AWG layer 270, so the light in the AWG structure 200 may be confined in the AWG layer 270. In other words, the light is transmitted in the AWG layer 270 and arrives at the end part 272. In some embodiments, the AWG structure 200 may include a top substrate 280. The top substrate 280 may cover the second cladding layer 260 to protect the underlying second cladding layer 260, AWG layer 270 and first cladding layer 250. In some embodiments, as shown in FIG. 2, the second cladding layer 260 and the AWG layer 270 may define a second interface 276 that connects to the oblique surface 400 and forms an angle with each other.

In some embodiments, as shown in FIG. 2, at least one of the first cladding layer 250 and the second cladding layer 260 may have an auxiliary oblique surface 410 that is extended from the oblique surface 400, and the auxiliary oblique surface 410 and the oblique surface 400 are substantially coplanar. In other words, the auxiliary oblique surface 410 is immediately adjacent to the first cladding layer 250, the second cladding layer 260 or both of them. As a result, when the light scatters from the AWG layer 270 to the first cladding layer 250, the second cladding layer 260 or both of them, the auxiliary oblique surface 410 may assist the scattering light transmitted in the first cladding layer 250, the second cladding layer 260 or both of them to redirect to the optical detector 300.

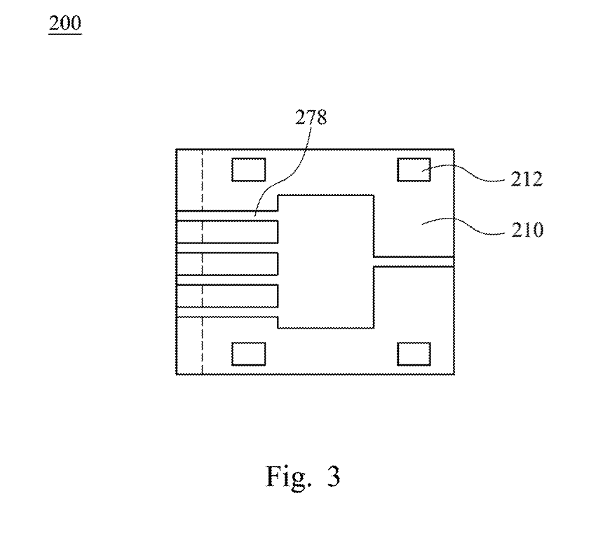

Reference is made to FIG. 1 and FIG. 3, in which FIG. 3 is a bottom view of FIG. 2. In some embodiments, as shown in FIG. 1 and FIG. 3, the optical connection module 10 may further include a bonding pad 110. The bonding pad 110 is configured to fix the AWG structure 200 on the substrate 100. More particularly, as shown in FIG. 1 and FIG. 3, the first surface 210 of the AWG structure 200 may have an alignment mark 212, and the substrate 100 may also have a substrate alignment mark 112 corresponding to the alignment mark 212 of the first surface 210. The bonding pad 110 may contact with the alignment mark 212 of the first surface 210 and the substrate alignment mark 112 of the substrate 100, so as to align the alignment mark 212 of the AWG structure 200 with the substrate alignment mark 112. As a result, it may ensure that the AWG structure 200 is located on an appropriate position of the substrate 100, so as to benefit the light in the AWG structure 200 to be transmitted to the optical detector 300. In other embodiments, the position of the bonding pad 110 may be different from the positions of the alignment mark 212 and the substrate alignment mark 112. Furthermore, in some embodiments, as shown in FIG. 3, the AWG structure 200 may include a plurality of optical channels 278. The optical channels 278 are separated from each other. By such a configuration, the optical channels 278 may transmit the light within different wavelength ranges. In other embodiments, the optical channels 278 may transmit the lights within substantially the same wavelength ranges.

In some embodiment, as shown in FIG. 1, the substrate 100 may have an engagement structure 120 configured to engage an optical passive device 500. The engagement structure 120 is farther away from the optical detector 300 than the AWG structure 200 being. The engagement structure 120 is designed to be disposed on a particular position of the substrate 100, and thereby the optical passive device 500 may align with the light input portion 230 of the AWG structure 200 by the engagement structure 120, so the light may be transmitted to the light input portion 230 of the AWG structure 200 through the optical passive device 500. As a result, the AWG structure 200 may align with the optical passive device 500 by the engagement structure 120, and it may assist the light to propagate into the AWG structure 200, which may benefit to increase the optical coupling efficiency of the optical connection module 10. For example, the optical passive device 500 may be, but is not limited to be, an optical fiber or a lens. Furthermore, in some embodiments, as shown in FIG. 1, the optical connection module 10 may further include a circuit board 600 and a driver 700, and the substrate 100 is disposed on the circuit board 600. The driver 700 is disposed on the circuit board 600, and the driver 700 is configured to drive the optical detector 300 or provide the optical detector 300 with an electric signal. The driver 700 and the optical detector 300 may be connected electrically by the wire M. In some embodiments, the engagement structure 120 may be, but is not limited to be, a groove structure formed by an etching process or a polishing process.

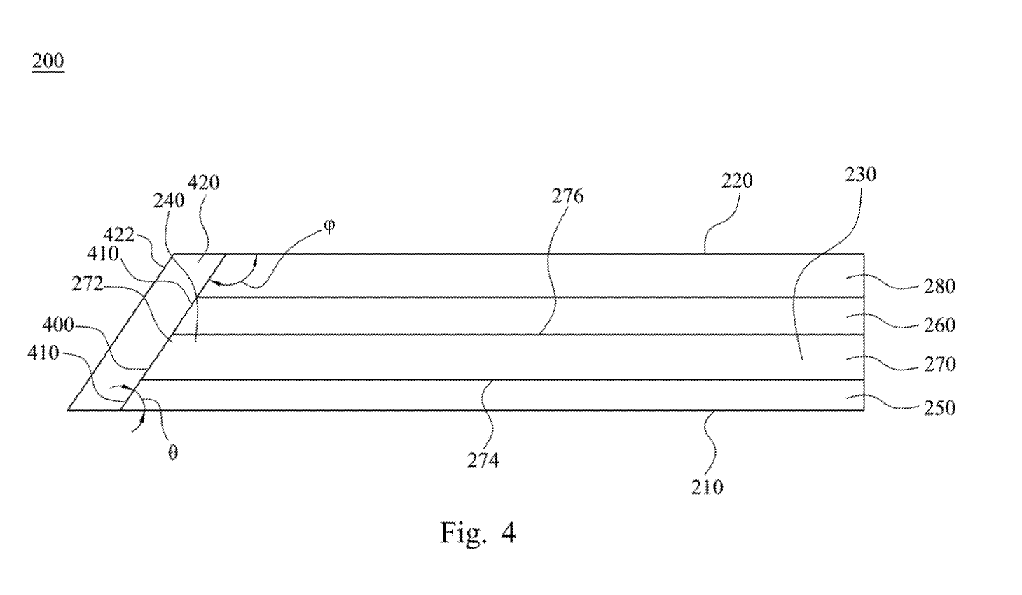

In some embodiments, as shown in FIG. 4, the optical connection module 10 may further include a reflective layer 420, and the reflective layer 420 is disposed on the oblique surface 400. More particularly, the reflective layer 420 may abut upon the oblique surface 400 or contact with the oblique surface 400. By such a configuration, portions of the light from the AWG structure 200 may be reflected to the optical detector 300 by the oblique surface 400, and the other portions of the light which are not reflected by the oblique surface 400 and penetrate through the oblique surface 400 may be reflected and redirected to the optical detector 300 by the reflective layer 420, so as to increase the chance that the light in the AWG structure 200 is reflected to the optical detector 300. As a result, by the oblique surface 400 and the reflective layer 420 abutting upon the oblique surface 400, the optical coupling efficiency of the optical connection module 10 may be increased. For example, in some embodiments, the reflective layer 420 may be, but it is not limited to be, a thin film with the higher reflectivity, such as a gold thin film, a silver thin film or other high reflectivity material thin films.

In some embodiments, as shown in FIG. 4, the reflective layer 420 may include a reflective surface 422 which is distant from the oblique surface 400, and the reflective surface 422 is substantially parallel with the oblique surface 400. In other words, the angle formed by the reflective surface 422 and the extended first surface 210 is substantially equal to the angle formed by the oblique surface 400 and the first surface 210. As a result, when the lights in the AWG structure 200 are respectively transmitted to the reflective surface 422 and the oblique surface 400, since an incidence angle of the light arriving at the reflective surface 422 is substantially equal to an incidence angle of the light arriving at the oblique surface 400, these lights may be reflected in equal reflection angles and redirected to the optical detector 300, which may assist to increase the light intensity where the optical detector 300 detect, so it may benefit to increase the optical coupling efficiency of the optical connection module 10.

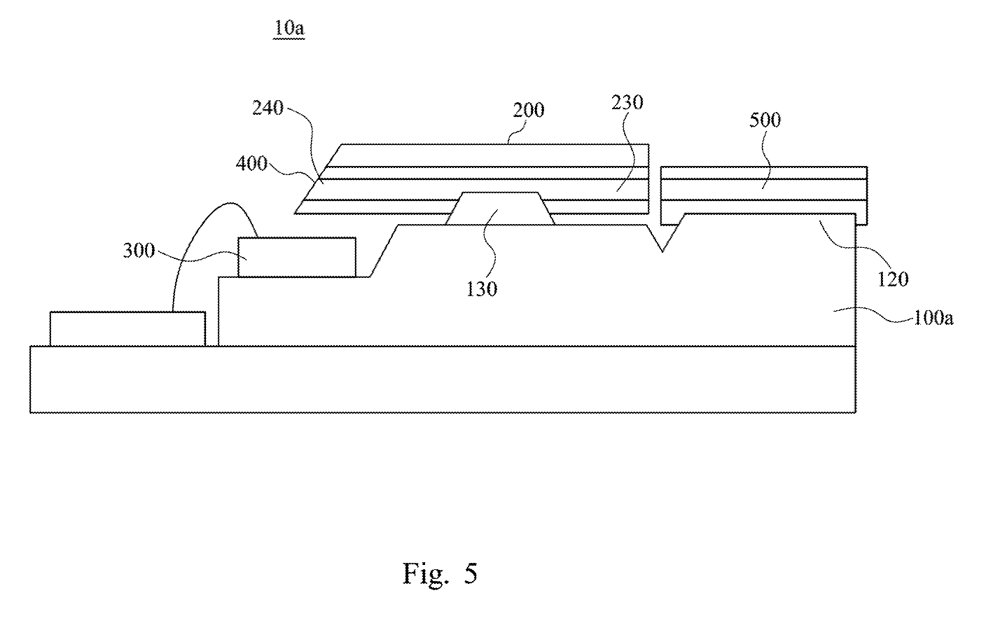

FIG. 5 is a cross-section view of an optical connection module 10a in accordance with other embodiments of the present disclosure. As shown in FIG. 5, the main difference between this embodiment and the foregoing embodiment is that: the substrate 100a may have an engagement structure 130, the AWG structure 200 is fixed on the substrate 100a by the engagement structure 130, and the bonding pad 110 may be omitted. The engagement structure 130 is designed to be located on the particular position of the substrate 100a, and thereby the AWG structure 200 may align with the optical detector 300 and the optical passive device 500 by the engagement structure 130, so the light may be transmitted to the light input portion 230 of the AWG structure 200 through the optical passive device 500, and the light may be transmitted to the optical detector 300 through the light output portion 240 of the AWG structure 200. As a result, the AWG structure 200 may align with the optical passive device 500 and the optical detector 300 by the engagement structure 130, and it may assist the light to propagate into the AWG structure 200 and into the optical detector 300, which may benefit to increase the optical coupling efficiency of the optical connection module 10a. For example, in some embodiments, the engagement structure 130 may be, but is not limited to be, concave or convex structures formed by an etching process or a polishing process. Although the present embodiment as shown omits the bonding pad 110, but in other embodiments, the bonding pad 110 and the engagement structure 130 may both be employed. In other words, the AWG structure 200 may be fixed by the bonding pad 110 and the engagement structure 130.

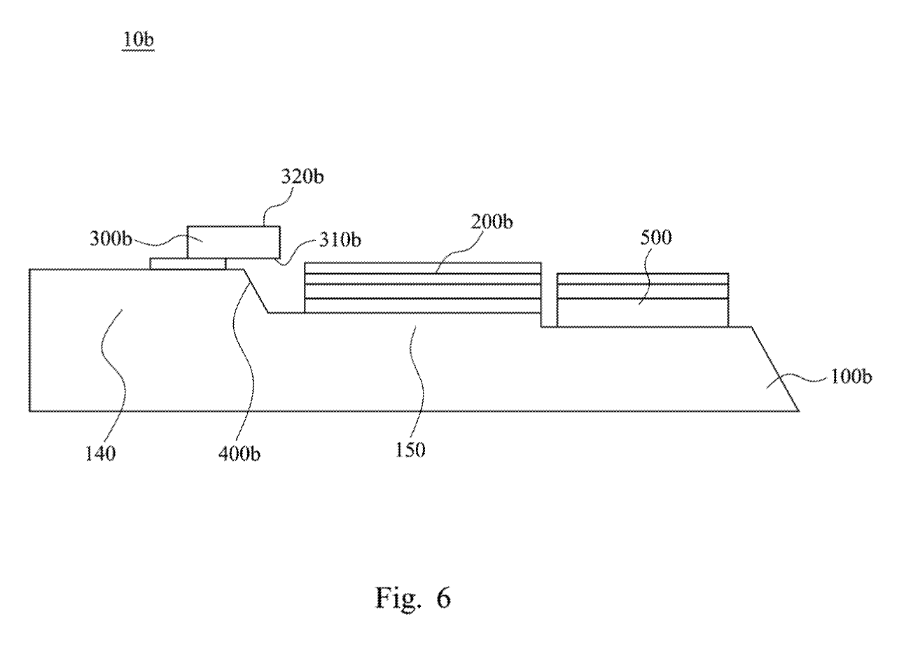

FIG. 6 is a cross-section view of an optical connection module 10b in accordance with other embodiments of the present disclosure. As shown in FIG. 6, the main difference between this embodiment and the foregoing embodiment is that: the substrate 100b may have a protrusion portion 140 protruding from the base portion 150 and a base portion 150, and the oblique surface 400 is located on the substrate 100b and connects the protrusion portion 140 and the base portion 150. The optical detector 300b is disposed on the protrusion portion 140, and the AWG structure 200b is disposed on the base portion 150. In other words, in some embodiments, the receiving surface 310b of the optical detector 300b is located on the bottommost part of the optical detector 300b. That is, the receiving surface 310b is closer to the substrate 100b than the rear surface 320b being, and the receiving surface 310b is configured to detect the light reflected by the oblique surface 400b and transmitted form the AWG structure 200b.

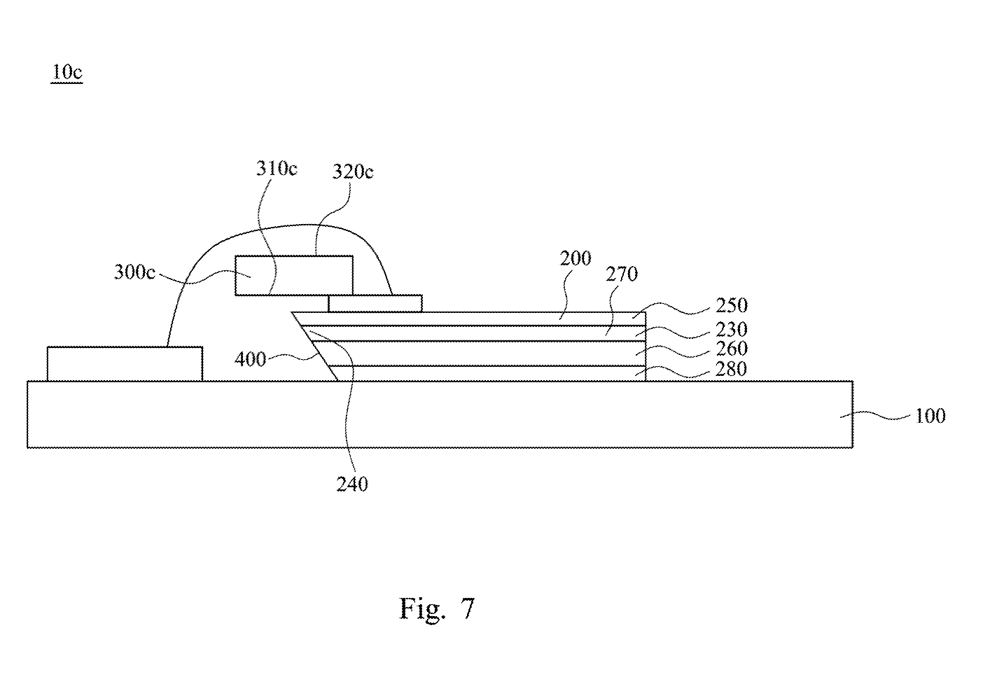

FIG. 7 is a cross-section view of an optical connection module 10c in accordance with other embodiments of the present disclosure. As shown in FIG. 7, the main difference between this embodiment and the foregoing embodiment is that: the optical detector 300c is disposed on the AWG structure 200. More particularly, as shown in FIG. 7, at least one portion of the optical detector 300c may cover the oblique surface 400. The receiving surface 310c of the optical detector 300c is located on the bottommost portion of the optical detector 300c. That is, the receiving surface 310c is closer to the AWG structure 200 and the oblique surface 400 than the rear surface 320c being. The oblique surface 400 may redirect the light in the AWG structure 200 to the receiving surface 310c of the optical detector 300c by reflection, which may increase the optical coupling efficiency of the light from the AWG structure 200 to the optical detector 300. As shown in FIG. 7, compared to FIG. 1, the AWG structure 200 is disposed reversely, so in the present embodiment, the top substrate 280 of the AWG structure 200 is the structure closest to the substrate 100. Therefore, in some embodiments, when the top substrate 280 and the substrate 100 have the same material (for example, the material of the top substrate 280 and the substrate 100 are silicon), the top substrate 280 and the substrate 100 may be formed by the same process. In some embodiments, the AWG structure 200 may omit the top substrate 280, and the second cladding layer 260 may be bonded to the substrate 100. In other words, in such an embodiment, the second cladding layer 260, the AWG layer, and the first cladding layer 250 may be directly formed on the substrate 100 and form the AWG structure 200.

In accordance with some embodiments of the present disclosure, the optical connection module utilizes the oblique surface, so that the light from the AWG structure can be redirected to the optical detector, and the optical receiving surface of the optical detector is not required to be perpendicular to a output light path of the AWG structure. Therefore, a circuit on the optical receiving surface of the optical detector is not required to be bended from the receiving surface to a lateral surface of the optical detector, thereby avoiding the out-of-plane bended circuit, which may benefit to transmit the high frequency signals. Furthermore, the substrate where the AWG structure and the optical detector are disposed is integrally formed, so as to shorten the optical path between the AWG structure and the optical detector, which may benefit to increase the optical coupling efficiency of the optical connection module.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An optical connection module, comprising:
a substrate;
an arrayed wavelength grating structure, configured to transmit a light, disposed on the substrate;
an optical detector, configured to detect the light propagating through the arrayed wavelength grating structure, disposed on the substrate; and
an oblique surface configured to redirect the light from the arrayed wavelength grating structure to the optical detector.

2. The optical connection module of claim 1, wherein the arrayed wavelength grating structure has a light input portion and a light output portion that are opposite, and the oblique surface connects to the light output portion.

3. The optical connection module of claim 1, wherein the oblique surface is located on the arrayed wavelength grating structure.

4. The optical connection module of claim 3, wherein the arrayed wavelength grating structure has a first surface and a second surface connected with the oblique surface the first surface opposite to the second surface is closer to the optical detector, and an angle formed by the oblique surface and the first surface is an acute angle.

5. The optical connection module of claim 4, wherein an angle formed by the oblique surface and the second surface is an obtuse angle.

6. The optical connection module of claim 1, the arrayed wavelength grating structure comprises:
a first cladding layer;
a second cladding layer, wherein the first cladding layer is closer to the optical detector than the second cladding layer being; and
an arrayed wavelength grating layer sandwiched between the first cladding layer and the second cladding layer, wherein the arrayed wavelength grating layer has an end part connected to the first cladding layer and the second cladding layer, and the oblique surface is located on the end part, and the first cladding layer and the arrayed wavelength grating layer define a first interface that connects to the oblique surface and forms an angle with each other.

7. The optical connection module of claim 6, wherein the second cladding layer and the arrayed wavelength grating layer define a second interface that connects to the oblique surface and forms an angle with each other.

8. The optical connection module of claim 6, wherein at least one of the first cladding layer and the second cladding layer has an auxiliary oblique surface that is extended from the oblique surface, and the auxiliary oblique surface and the oblique surface are substantially coplanar.

9. The optical connection module of claim 1, further comprising a reflective layer disposed on the oblique surface.

10. The optical connection module of claim 9, wherein the reflective layer has a reflective surface distant from the oblique surface, and the reflective surface is substantially parallel with the oblique surface.

11. The optical connection module of claim 1, wherein the substrate has a protrusion portion and a base portion, the protrusion portion protrudes from the base portion, and the oblique surface is formed on the substrate and connects the protrusion portion and the base portion, the optical detector is disposed on the protrusion portion, and the arrayed wavelength grating structure is disposed on the base portion.

12. The optical connection module of claim 1, further comprising at least one bonding pad, wherein the bonding pad is sandwiched between the substrate and the arrayed wavelength grating structure.

13. The optical connection module of claim 1, wherein the substrate has at least one engagement structure, the engagement structure is farther away from the optical detector than the arrayed wavelength grating structure being, and the engagement structure is configured to engage an optical passive device.

14. The optical connection module of claim 1, wherein the substrate has at least one engagement structure, the arrayed wavelength grating structure is engaged with the engagement structure.
